(19) United States
(12) Patent Application Publication
(10) Pub. No.: US 2026/0172429 A1
(43) Pub. Date: Jun. 18, 2026

(54) HIGH ASSURANCE DATA VERIFICATION

(71) Applicant: QINETIQ LIMITED, Farnborough Hampshire (GB)

(72) Inventors: Anton De Braal, Malvern, Worcestershire (GB); David Hughes, Malvern, Worcestershire (GB)

(73) Assignee: QINETIQ LIMITED, Farnborough Hampshire (GB)

(21) Appl. No.: 19/126,420

(22) PCT Filed: Nov. 2, 2023
(86) PCT No.: PCT/EP2023/080513

§ 371 Date: May 1, 2025

(30) Foreign Application Priority Data
Nov. 2, 2022 (GB) 2216279.6

(51) Int. Cl. H04L 9/40

(52) U.S. Cl. CPC H04L 63/123

(57) ABSTRACT

A method for use in a content checking device for checking data transmitted from a first computer system to a second computer system. The method includes receiving a set of input data from the first computer system, wherein the set of input data is received in a first format. The method also includes transforming the set of input data from the first format to an intermediate format which is known to the content checking device, wherein the intermediate format has a canonical data structure comprising a set of unambiguous serialised data portions, determining whether the set of input data is valid by comparing a data portion to reference data for that data portion, and controlling the flow of input data to the second computer system based on the determination.

### FIELD

The present invention relates to a computer-implemented device and method for checking and verifying the validity of data which is to be transmitted between two or more separate computer systems, such as those that belong to separate computer networks.

### BACKGROUND

It is often necessary to exchange data between separate computer systems, including those that belong to computer networks of different trust or security levels (i.e. different security domains). For example, it may be necessary to transfer data from one network or domain, such as the Internet or other untrusted network, to a more trusted or sensitive domain such as but not limited to a corporate system containing sensitive intellectual property, trade secrets, or personal data. However, in practice it is very difficult to ensure that the data transfer is safe and secure for the receiving system, especially when the data transfer is with respect to a “rich data” format which includes different data types (such as text and image data types etc. within the same data file).

Known examples of rich data formats include: XML, XMPP messages, Data Distribution Services (DDS), or structured document formats such as Microsoft Word, Microsoft Excel, or Rich Text Format. These data formats are prone to manipulation in that malicious content such as malware can be more easily hidden within the complex data structure. On the receiving computer system, programs that interpret rich data may be caused to execute malicious code by malware inside the rich data, for example by the program executing code with numbers outside the normal functioning range.

A previous approach for securely transferring rich data between separate computer networks is referred to as “transcoding”, in which a document is translated from a rich data format to a relatively simpler, safer format which includes fewer data types (and in some cases only one data type) before it passes from one system to another. Examples include converting a JPEG image to BMP, or flattening a document into images (one image per rendered page). The purpose of this technique is to destroy any hidden information that might be encoded in the original document's data structures, and to ensure that the delivered document is in a normal format that will be safely handled by the recipient application. An example of this approach is disclosed in patent publication WO 2005/085971A1 entitled “Threat mitigation in computer networks”. A problem with such systems, however, is that the reformatting process is a lossy one which loses much of its original data or information content.

Accordingly, it is an object of the present invention to provide a method and device for verifying, with high assurance, the validity of data which is transmitted between computer systems that overcome the above problems.

### SUMMARY OF THE INVENTION

According to an aspect of the present invention, there is provided a method to be used in a content checking device for checking data transmitted from a first computer system to a second computer system. The method comprises: receiving a set of input data from the first computer system, wherein the set of input data is received in a first format; transforming the set of input data from the first format to an intermediate format which is known to the content checking device, wherein the intermediate format has a canonical data structure comprising a set of (e.g. unambiguous) serialised data portions; determining whether the set of input data is valid by comparing a data portion to reference data for that data portion; and controlling the flow of input data to the second computer system based on the determination.

The content checking device and method of the present invention may determine whether portions of the input data conform to a specified allowable criteria (defined by the reference data), to protect downstream consumers/parsers of the input data. This may be in contrast to hypothetical systems which look for malware signatures in the input data. In that regard, signature based malware detection looks for patterns of code that correspond to specific malware, i.e. it positively identifies the presence of malware. This is the opposite of determining that the input data meets allowable criteria. By checking for conformance to strict specifications, the present invention may reduce the attack surface, and in effect reduce the probability that a vulnerability in a consuming application (that has implemented logic to read and interpret the input data) will be exploited by an attacker trying to craft the input data to trigger such an exploit.

In embodiments, the method of the present invention may be said to be signature-less in that it does not look for malware signatures in the input data. Further, signature-based methods are limited in that they cannot identify previously unknown attacks, or variants of existing attacks, that do not match any signature in the database. The present invention on the other hand may work both for known and unknown threats.

The transformation from the first format to the intermediate format may be a lossless one, e.g. such that the intermediate format (and in embodiments a final format to be sent to the second computer system) comprises data having the same richness as the first format. That is, the present invention may preserve data richness of the original input data and does this by, for example, dividing it into different data portions according to data type(s). In the intermediate format, all of the original input data may be present except that it has been reformatted in a way that allows each portion to be validated with more accuracy. The transformation may divide the input data into data portions without changing the data type(s). That is, the intermediate format may be a format which maintains the data type(s) in the original input data.

A or each serialised data portion of the set may comprise header information and payload information. Comparing a data portion to reference data may comprise comparing the payload information to the reference data.

The canonical data structure may be a hierarchical nodal data structure wherein each data portion corresponds to a node and one or more of the data portions are embedded within a payload of another data portion.

The canonical data structure may be flattened in that the data portions are stored and processed independently of one another.

A data portion of the set of input data may comprise text string data. The reference data may comprise one or more predefined text strings which represent banned or denied information. Comparing the data portion to the reference data may comprise comparing the text string data to the predefined text string. The set of input data may be determined to be invalid if the data portion comprises a text string that matches the predefined text string.

The method may further comprise skipping or ignoring at least one whitespace character of the text string data when comparing the text data string to the predefined text string.

The method may further comprise, in response to determining that the set of input data is not valid: discarding or ignoring the set of input data such that it is not used by the second computer system; or modifying the set of input data such that the modified set of input data is suitable for use by the second computer system.

The step of determining whether the set of input data is valid by comparing a data portion to reference data may be carried out by hardware, such as one or more field-programmable gate arrays or an application-specific integrated circuit.

The transformation may divide the input data into data portions without changing the data type(s). That is, the intermediate format may be a format which maintains the data type(s) in the original input data. Each serialised data portion may comprise data having a single data type only. Respective data portions may comprise data having different data types, and the reference data to be used in the comparison with a given data portion is specific to the data type of the data portion. Comparing a data portion to reference data may be performed by passing the data portion to a programmable logic verification engine that has been preconfigured to compare one or more attributes of the data portion to reference data defined for the data type. The verification engine may be configured for only one of the data types, to perform content checking which is dependent on and dedicated to said one of the data types only. Thus the invention may perform different content checks for respective data portions into which the input data has been divided. Performing data type-specific checks on a data portion by data portion basis is in contrast to hypothetical systems which reformat the entire, rich input data file to executable binary code/files and perform the same checks for the entire executable binary code/files.

The reference data for a given data portion may indicate a predefined condition which can be used by the content checking device to characterise the data portion as being valid or invalid. The method may comprise checking whether the content of the data portion satisfies the predetermined condition stipulated by the reference data for the data portion, and determining whether the set of input data is valid or invalid based on the result of that.

Determining whether the set of input data is valid may further comprise checking that the set of input data has been correctly transformed to the intermediate format by comparing the set of input data with predefined reference data that indicates a valid data structure.

The step of comparing a data portion to reference data for that data portion may be only performed on the condition that the set of input data has been correctly transformed to the intermediate format.

The method may comprise, in response to determining that the set of input data is valid, converting the set of input data from the intermediate format to a final format which is for use by the second computer system.

The final format may be the same as the first format, though in embodiments the final format may be the same as the first format in all respects other than with respect to invalid data portions that have been modified or removed.

The content checking device may comprise a processing core of programmable logic verification engines which are suitable for comparing respective data portions to reference data. The verification engines may be configured prior to receipt of input data by the content checking device (e.g. based on foreknowledge of the input data to be received) or dynamically configured in response to receipt of the input data by the content checking device. In that regard, the reference data may specify a known or predicted number of data portions in the set of input data and the core is dynamically configured for the set of input data to activate a number of verification engines which matches the known or predicted number of data portions.

In embodiments where the data portion is passed to a programmable logic verification engine that has been preconfigured to compare one or more attributes of the data portion to reference data defined for the data type, and the reference data for a given data portion indicates a predefined condition which can be used by the content checking device to characterise the data portion as being valid or invalid: the predefined condition may be specific to a known or predicted data type of the data portion in the set of input data; and a verification engine may be dynamically configured for the set of input data to check whether the content of the data portion satisfies the predetermined condition which is specific to the data portion.

According to another aspect of the present invention, there is provided a content checking device, comprising: an input transformation engine configured to receive a set of input data from a first computer system in a first format and transform the set of input data from the first format to an intermediate format which is known to the content checking device, wherein the intermediate format has a canonical data structure comprising a set of unambiguous serialised data portions; and a core which is configured to determine whether the set of input data is valid by comparing a data portion to reference data; wherein the content checking device is further configured to control the flow of input data to the second computer system based on the determination.

The core may be implemented on hardware, such as one or more field-programmable gate arrays or an application-specific integrated circuit.

The set of input data may comprise plural data types and each data portion may include data of a respective one of the data types only. The core may comprise a plurality of verification engines. Each verification engine may be configured to process a respective data portion only, by comparing the data portion to reference data for that data type only.

The device(s), processor(s), controller(s) and/or functional blocks (and various associated elements) described herein may comprise any suitable circuitry to cause performance of the methods described herein and as illustrated in the Figures. The device, processor or controller may comprise: at least one application specific integrated circuit (ASIC); and/or at least one field programmable gate array (FPGA); and/or single or multi-processor architectures; and/or sequential (Von Neumann)/parallel architectures; and/or at least one programmable logic controllers (PLCs); and/or at least one microprocessor; and/or at least one microcontroller; and/or a central processing unit (CPU), to perform the methods.

The device(s), processor(s), controller(s) and/or functional blocks may include at least one microprocessor and may comprise a single core processor, may comprise multiple processor cores (such as a dual core processor or a quad core processor), or may comprise a plurality of processors (at least one of which may comprise multiple processor cores).

The device(s), processor(s), controller(s) and/or functional blocks may be part of a system that includes an electronic display, which may be any suitable device for conveying information, e.g. the result of data content checking, to a user.

The device(s), processor(s), controller(s) and/or functional blocks may comprise and/or be in communication with one or more memories that store the data described herein, and/or that store software for performing the processes described herein.

The memory may be any suitable non-transitory computer readable storage medium, data storage device or devices, and may comprise a hard disk and/or solid state memory (such as flash memory). The memory may be permanent non-removable memory, or may be removable memory (such as a universal serial bus (USB) flash drive).

The memory may store a computer program comprising computer readable instructions that, when read by a processor or controller, causes performance of the methods described herein, and as illustrated in the Figures. The computer program may be software or firmware, or may be a combination of software and firmware. In some examples, the computer readable instructions may be transferred to the memory via a wireless signal or via a wired signal.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein

### BRIEF DESCRIPTION OF THE DRAWINGS

Embodiments of the invention will now be described by way of non-limiting example with reference to the accompanying drawings, in which:

FIG. 1 is a high level schematic diagram of a content checking device in accordance with the present invention;

FIG. 2 is a flow chart schematically illustrating a method for checking data transmitted from a first computer system to a second computer system, using the content checking device of FIG. 1;

FIG. 3 is a block diagram schematically illustrating an intermediate data format for the input data, in accordance with an embodiment which of the present invention;

FIG. 4 is an example of discretised input data which is to be checked using the content checking device of the present invention;

FIG. 5 is a block diagram schematically illustrating a core of the content checking device, in accordance with one embodiment;

FIG. 6 is a block diagram schematically illustrating a core of the content checking device, in accordance with another embodiment;

FIG. 7 is a block diagram schematically illustrating a core of the content checking device, in accordance with another embodiment;

FIG. 8 is a block diagram schematically illustrating the core of the content checking device in accordance with an embodiment; and

FIG. 9 is a flow diagram schematically illustrating the method of using the content checking device for checking data transmitted from a first computer system to a second computer system, in accordance with an embodiment.

### DETAILED DESCRIPTION

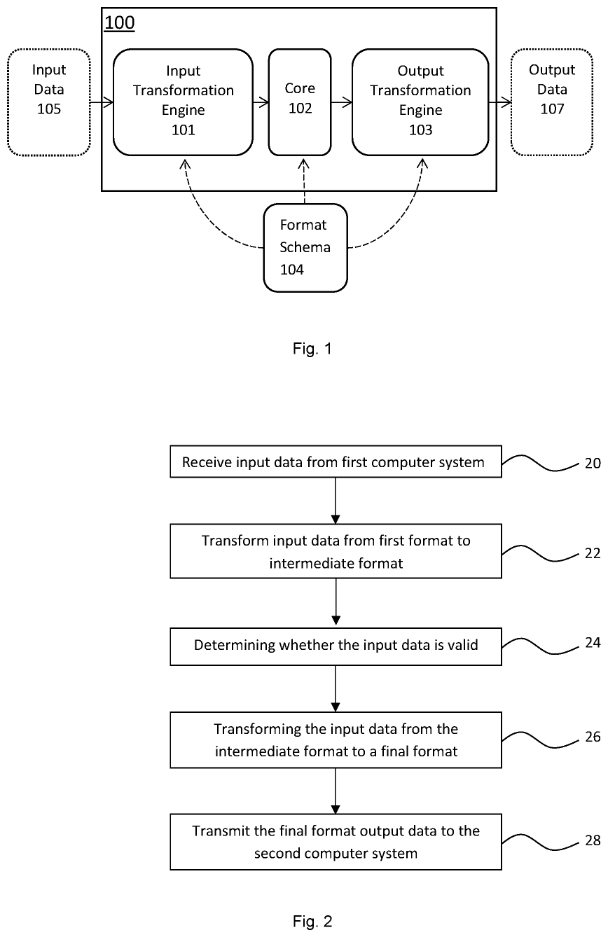

FIG. 1 schematically illustrates a content checking device 100 in accordance with an embodiment of the present invention. In use, the device 100 is located between, and is in communication with, two computer systems (not shown) which are to exchange data. The device 100 acts as an intermediary for controlling the flow of data from one of the computer systems to the other.

For ease of explanation, the device 100 is described below with reference to regulating the import of data transmitted by a first computer system within an untrusted domain (such as the global internet) and received on a second computer system belonging to a trusted domain such as a sensitive corporate network or other sensitive system. However, it will be appreciated that the device 100 can be used to control data exchange between computer systems of any trust or security levels. For example, the device 100 could be used for regulating the import of data from a trusted domain to an untrusted domain, in order to protect against accidental or malicious exfiltration of data from the trusted domain, which may happen where communications channels and/or exfiltration paths are disrupted (e.g. by ensuring all unused fields are removed or set to zero during deep content checking). The device 100 may also facilitate secure bi-directional data transfer by the use of multiple channels through the device 100, each channel regulating uni-directional data transfer in the manner described below. Alternatively, there may be two or more physically separate content checking devices 100, one device 100 for each direction of data transfer between two systems.

In the illustrated embodiment, the device 100 is physically separate from the first computer device and the second computer device. For example, the device 100 may be a network node with which both computer system communicate. In other embodiments, however, the device 100 may be part of one of the computer systems, e.g. in the form of a network interface card in a computer. There may be a device 100 in each computer system.

The device 100 comprises an input transformation engine 101, a core 102, and an output transformation engine 103. The input transformation engine 101 and the output transformation engine 103 are implemented in software (computer executable instructions), for example in a system on a chip (SoC), but may instead be implemented in hardware. The core 102 is implemented in hardware. Such a hardware implementation is deterministic and does not rely on an unassured software stack, and so is highly assurable. That is, by implementing the content checking elements of the system in hardware, the content checking functions cannot be tampered with, leading to high security assurance of the device and its security enforcing functions.

The hardware is preferably (re)programmable logic on an FPGA(s). In such embodiments, the FPGAs may be pre-configured to perform the content checks for a given set of input data, and may be updated or reconfigured dynamically depending on the data types in the set of input data received. The data types in the set of input data may be known to the device (e.g. based on runtime information) and may be indicated to the core 103 by reference data, or may be predicted based on statistical information (e.g. previous data types or runtime information) recorded and stored as reference data for historical input data received from the same or similar source domain as that of the first computer system. In alternative embodiments to FPGA(s), the hardware is an application specific integrated circuit (ASIC) which is fixed in silicon.

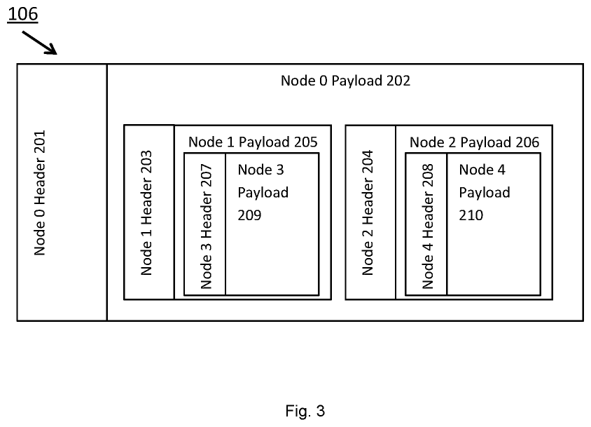

With reference to both FIGS. 1 and 2, the device 100 receives a set of discretised input data 105 (step 20 of FIG. 2) from the first computer system and passes it to the input transformation engine 101. The set of input data 105 received by the device 100 at this stage will typically be in the form of rich data, and have one of the following data formats: XML, XMPP messages, DDS, or structured document formats such as Microsoft Word, Microsoft Excel, or Rich Text Format. In embodiments, the input data may be signed in programmable logic, to facilitate proof of authenticity should downstream sub-devices or components (such as the input transformation engine 101) need to authenticate the data.

As stated above, rich data is prone to manipulation in that malicious content can be hidden within the data structure, or the data structures themselves malformed, such that they may exploit vulnerabilities in the target data consumer (e.g. a software parsing component of a desktop application). Accordingly, at step 22, the input transformation engine 101 operates to convert the original input data 105 from its first, original format to an intermediate format which is more suitable for allowing respective data types of the input data to be examined, and is unambiguous in its interpretation. Specifically, the input transformation engine 101 abstracts and transforms the input data 105 into a canonical format which comprises a set of serialised data portions, where each data portion comprises input data of a single data type only. Data which is in the intermediate format may be referred to herein as the “Unambiguous Serial Protocol (USP)”.

The conversion is made in accordance with a format schema 104, which is known to the input transformation engine 101 (for example, the format schema 104 may be communicated to, or loaded onto, the device 100 before use). The format schema 104 indicates and defines the intermediate format to which the input data 105 is to be converted. Specifically, the format schema 104 defines the data structure to be used as the intermediate format and also where within that data structure the input data of different data types are to be located. For example, the input data 105 may comprise text characters (i.e. a string data type) and image pixel data (i.e. a numerical integer data type) etc., and the format schema 104 will indicate different locations within the data structure at which the text characters and pixel data are to be stored. Typical data types include, but are not limited to: string [e.g. UTF-32, restricted UTF-8 set], decimal, integer [e.g. uint8, uint16, uint32, uint64, int8, int16, int32, int64, variants], floating-points [e.g. float32, float64 (doubles)], boolean (true/false), date and time. Other suitable data types include: image types [e.g. bitmap]; audio [e.g. WAV file]; video and custom-defined types.

It will be appreciated that the format schema may differ from input data to input data, depending on the data types which are to be contained in the rich input data 105. The device 100 may be pre-configured with a specific format schema for a given application, e.g. if it is known which type of data is to be transferred between the first and second computer systems. Where the input data 105 is an XML document, for example, the format schema 104 may represent a particular XML schema definition (XSD). Where the input data 105 is a JPEG image, the format schema may describe the permitted or expected structure of the metadata and constraints on the data field content.

The output of the input transformation engine 101, i.e. the USP data, is passed to the hardware-implemented core 102 of the device 100. At this point, the method proceeds to step 24 of the method of FIG. 2, at which the core 102 operates by determining whether the input data 105 is valid or invalid. Specifically, the high assurance core 102 checks the input data 105 for malicious content, malformed data, or markers that indicate manipulation of the input data 105, and determines whether the input data 105 is valid based on that.

The validity of the input data 105 is checked by comparing the content of one or more or all of the serialised data portions to predetermined reference data, corresponding to the rules or policy encoded in the reference data (in the form of constraints on the data and structure). The reference data for a given data portion (of which there may be more than one) indicates a condition (or set of conditions) which can be used by the core 102 to characterise a data portion as being valid or invalid according to the reference data. Accordingly, the core 102 checks whether the content (e.g. one or more attributes or elements) of the data portion satisfies a predetermined condition stipulated by the reference data for the data portion, and determines whether the input data 105 is valid (or invalid) based on the result of that. It will be appreciated that the exact condition to be used in the check of a given data portion will depend on the nature of the check that is to be performed, which itself will depend on the data type stored in the data portion and/or how the input data is to be used by the second computer system.

A condition may be considered as either a positive condition or a negative condition. If a positive condition is satisfied by the (attribute or element of the) data portion, then this is taken by the core 102 as an indication that the data portion is valid. Conversely, if a positive condition is not satisfied by the (attribute or element of the) data portion, then this is taken by the core 102 as an indication that the data portion is invalid. If a negative condition is satisfied by the (attribute or element of the) data portion, then this is taken by the core 102 as an indication that the data portion is invalid. If, however, a negative condition is not satisfied by the (attribute or element of the) data portion, then this is taken by the core 102 as an indication that the data portion is valid. The reference data indicating the conditions may form part of the format schema 104, which further stipulates the expected manner in which the input data is to be divided into serialised data portions (e.g. the structure and ordering of the data elements).

### Examples of Positive Conditions Include:

if an attribute string of the data portion matches exactly one string, or one of a stored set of allowable strings
if an attribute uint32: BGColor (which represents #RRGGBB values as bytes) in the data portion is sensible, or a simple integer
if latitude and/or longitude values in the data portion are within predefined maximum and minimum limits
if a data type meets certain restrictions (‘facets’ or constraints) including: minimum or maximum values (e.g. 0<=value<=120); length, maximum length or minimum length; enumeration (e.g. value can only be one of a predefined set); pattern (a pattern-matching (e.g. Regular Expresion (RegEx)) constraint that, e.g. limits ‘letter’ type to be only one lower-case letter using ‘[a-z]’, or only one of a specific set of values ‘[xyz]’, with zero or more (*) or one or more (+), and character lengths ({8}))
etc.

An example of a negative condition includes:
if the data portion comprises a predefined text string, which represents a banned phrase, word or information.

It will be appreciated here that, where the input data comprises text strings, the method may further comprise skipping or ignoring at least one whitespace character when comparing the text string to the predefined reference data (the predefined text string). In this way, the method effectively compresses the data before it is checked, which can lead to more efficient processing. It also increases the hit-rate of matches.

The core 102 determines what action is to be taken with respect to the input data 105, based on the results of the checks described above with respect to step 24 of FIG. 2. If the checks reveal that all of the data portions are valid, then the core 102 determines that the input data 105 is valid and is safe and secure for onward transmission to the second computer system. Otherwise, if one or more data portions are invalid, then the core 102 determines that the input data 105 is invalid and will control the flow of input data 105 to ensure that invalid data (e.g. data that may pose a security threat) is not transmitted to the second computer system.

Accordingly, in response to determining that the input data 105 is valid, the method proceeds to step 26 of FIG. 2, at which the output transformation engine 103 converts the input data 105, having been converted into the intermediate format, to a final format which is to be used by the second computer system. The final format can be any format which is suitable for being interpreted and read by the second computer system. However, to maximise assurance of the device, in this embodiment the final format is the same as the first, original format in which the input data 105 was received by the input transformation engine 101. This conversion is also based on the format schema 104, in that knowledge of how the input data 105 was converted from the first format to the intermediate format could be used to reverse the process.

In response to determining that the input data 105 is invalid, the core 102 will not output invalid input data content to the second transformation engine 103. For example, the core 102 will discard or ignore the entire set of input data 105 to prevent any invalid data portions being sent to and used by the second computer system. In an alternative embodiment, in response to determining that the input data 105 is invalid, the core 102 modifies the set of input data such that it is suitable for use by the second computer system. In embodiments, the core 102 removes (e.g. strips or excises), the invalid data portions of the input data 105 and the resultant data is reconstituted without the excised data at the output transformation engine 103. In another embodiment the invalid data portion(s) remains but its values are modified, e.g. zeroed or set to a desired non-zero value(s), before being forwarded to the output transformation engine 103 for reformatting to the final format.

In one embodiment, the core 102 additionally outputs the results of the content checking (e.g. providing a list of the invalid data portions detected (and associated metadata)). This may allow for debugging, and also for determining the issues with the input data. In further embodiments, the core 102 processes the entirety of the transformed input data, takes action to control the onward flow of invalid data content to the second computer system, but records and outputs the result of the content checking for each data portion (or for only those that are determined to be invalid). By providing the user with an output that identifies all of the invalid data portions in the entirety of the input data, e.g. lists the failures detected, as well as any associated information, the invention enables an efficient way of identifying issues or threats within the input data and ways of debugging the input data.

The method of FIG. 2 will then finish at step 28, at which the reformatted set of input data 105 is transmitted to (or, if the device 100 is part of the second computer system, read by) the second computer system.

Protocol breaks may be implemented either side of the core 102, between the core 102 and input/output transformation engines 101, 103. Alternatively, protocol breaks may be implemented before the input transformation engine 101, and after the output transformation engine 103. A protocol break is operable to strip network-level (OSI layer 3) and higher application-level protocols, for example data (OSI layers 5-7) or transport layer (OSI layer 4) protocols, thereby mitigating attacks via these channels. In this way only the input data ‘business content’, for example the XMPP message, or structured document, is processed by the core 102. Where protocol breaks are used, the network level protocols may be added back to the checked input data to allow transmission via a network to the second computer system. Hardware data diodes may also be optionally implemented in the device, preferably directly before the input transformation engine 101 and directly after the output transformation engine 103.

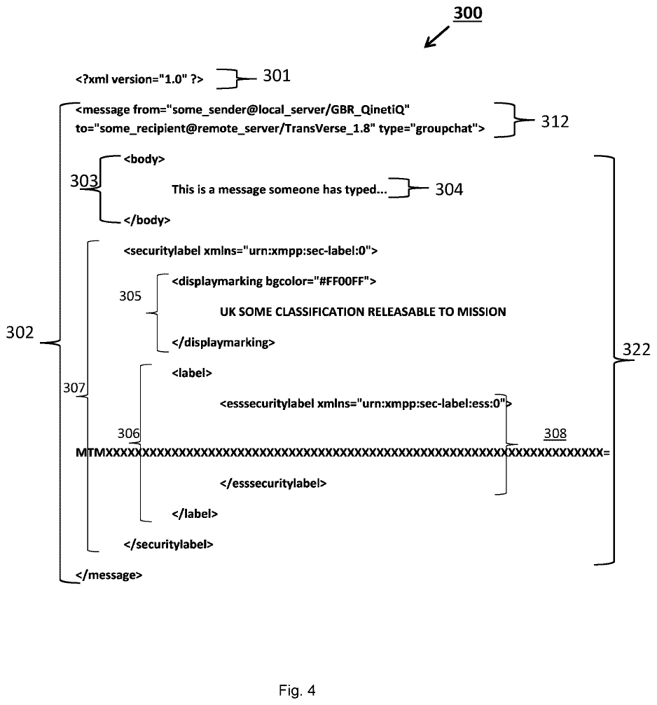

FIG. 3 schematically illustrates input data 105 which is structured in accordance with one example of the USP (intermediate format) 106. In this embodiment, the intermediate format 106 has a nested or hierarchical nodal structure, where the input data 105 has been parsed by the input transformation engine 101 and split into a series of data portions in the form of nodes in a nested node list. A node is a basic unit in the nested data structure and represents a respective data portion into which the input data 105 has been divided.

Each node corresponds to and comprises an input data portion of a single data type, and comprises a node header 201, 203, 204, 207, 208 and a node payload 202, 205, 206, 209, 210. Where the input data 105 is an XML file, for example, each node represents an element in the XML tree.

The node header 201, 203, 204, 207, 208 provides processing information about the unit of data, which can be used by the core 102 to determine how to effectively process the data. The node header includes:
Node Index—a unique identifier that references a particular node data type specified in the format schema 104
Node Size—the size of the node, including the header and the payload but excluding the node index bytes
and one or more of the following:
Global Unique Identifier (GUID)—a unique reference number, which may be used for internal referencing.
Node Depth—the depth of the node (within the nested hierarchy) from the uppermost (root) parent node.
Depth Position—position of a child node within its parent.
Context Vector/Context Matrix—includes the relative position and attributes of all parent nodes for a given node.
   Context Type—either Context Vector or Context Matrix
   Context Size—size of the Context Vector or Context Matrix, in bytes.
   The Context Vector is the simple case where only the ordered list of parent Node Indexes (from Depth=0 to Depth 32 current depth−1) are maintained, nodes do not have attributes, and no other context is required to be captured. E.g. <Node Index==0><Node Index==3><Node Index==45><Node Index==2><Node Index==?>. . .
   The Context Matrix is a multi-dimensional depth-ordered set of Context Attribute Vectors, which contains the Node Index (as in the Context Vector) along with additional context.
Node Attribute Map—contains an ordered list of the attributes (key-value pairs) of this Node
   node attribute map size-the size of the node attribute map
   The ordered list of key-value pairs, which are optionally stored as simple nodes themselves

In this embodiment, input data 105 is converted into a canonical data format that is serialised as: <Node Index><Node Size><GUID><Node Depth><Depth Position><Context Vector/Matrix><Node Attribute Map>. The node list begins at depth position 0, and lists the nodes in the order that they appear at depth position 0, itself stored in the format of a node (with Node Index==0, Global Unique Identifier==0, Depth==0, depth position==0, and Context Vector/Context Matrix empty).

It will be appreciated here that the format schema 104 may also include the above information for each node.

The node payload 202, 205, 206, 209, 210 comprises the content of the input data 105 for a data portion to which the node relates, and/or one or more nested nodes. In some embodiments, the content may be absent from the node list and instead be represented by the GUID in the node header. For example, the GUID may be used for internal referencing and may reference out to memory containing large data content, such as bitmaps or large portions of text, where these are not included in their nested USP position. The large nodes are preferably represented by a Global Unique Identifier of the actual content where these are not included in their nested unambiguous serial protocol position, and are brought out at Depth position 0. This also allows the node lists to be verified before or at the same time as the node payload, for performance or other architectural reasons (e.g. for scalability, resource limitations of the programmable logic or floor-planning). In this way large nodes may be checked separately by other logic in the core 102, and in parallel. Such parallel processing reduces overall checking time, and is ideally suited to hardware-based implementations (e.g. FPGA).

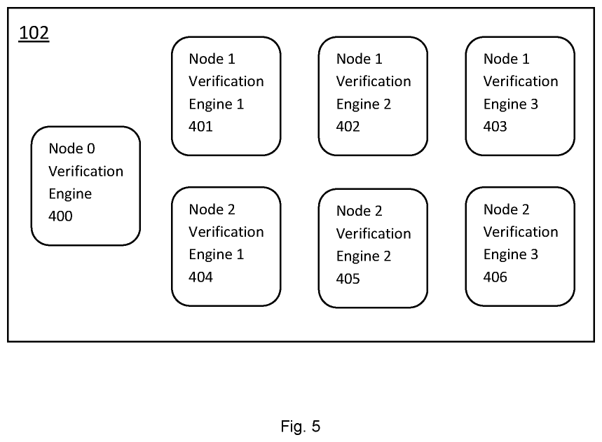

FIG. 4 is an example of discretised input data 105 in the original format of an XMPP chat message 300. At the input transformation engine 101, the message 300 is parsed and divided into multiple nodes 301, 302, 303, 305, 306, 307, 308 including headers 312 and payloads 304 and322. In the example shown in FIG. 4, payload 304 is contained in a child node of parent node 303.

Excluding context vectors, context matrices, node depth and node size, the blocks of information in FIG. 4 as serialised are (up to “ . . . ”):
<Node 1><Node 2: attributes(<Attrib 1>(<uint64: StringLen><UTF 32-String: SenderID>) <Attrib 2>(<uint64: StringLen><UTF 32-String: RecipientID>) <Attrib 3>(<uint64: StringLen><UTF 32-String: Type>)) content(<Node 3: content(<uint 64: StringLen><UTF 32-String: MessageText>)><Node 4 ·attributes(<Attrib 4>(<uint64: StringLen><UTF 32-String: XMLNameSpace>) content(<Node 5 attributes(<Attrib 6>(<uint32: BGColor>>) content(<uint64: StringLen><UTF32-String: DisplayMarking>)> . . . ))>
   In the canonical intermediate format data 106, this information is represented (up to “ . . . ”) as:
1<SIZE OF NODE 1==0>2 <SIZE OF NODE 2>(4627<SIZE OF NODE 4627>(36 “some_sender@local_server/GBR_QinetiQ”) 4283(43 “some_recipient@remote_server/TransVerse_1. 8”) 4261(9 “groupchat”) 3<SIZE OF NODE 3>(116 “This is a message someone has typed . . . </n>4(. . .))

It is to be noted here that the true canonical format 106 will not include brackets. These are merely shown above to aid interpretation and grouping of node information. Further, “Attrib 1” is an unsigned integer that represents a particular Attribute, similar to a Node.

Attributes are used to provide information about an element or node, for example node 4, 307, has the attribute “xmlns=”urn:xmpp:sec-label: 0”. <define attributes>, and are specified as simple types, with a name, data type, a fixed/default value specifier, and a usage specifier (whether the attribute is required or optional).

Nodes for input data which is XML-based may also have further restrictions called ‘Indicators’. An ‘indicator’ is an element attribute which defines how child elements are used. Indicators may include:
Order Indicators—All (child elements can appear in any order, and zero or one times), Choice (either one child element appears, out of a set of choices), and Sequence (child elements must appear in the exact order)
Occurrence Indicators—maxOccurs (the maximum number of times an element must occur), minOccurs (the minimum number of times an element must occur)
Group Indicators—Group name (defines a group of elements), attributeGroup name (defines a group of attributes)

Although the intermediate format has been described above with respect to a nested node structure, this is not required. In embodiments, rather than having nested nodes embedded in node payloads, the canonical input data 106 is flattened, such that the nodes are not embedded within other nodes and can be treated, i.e. stored, read, processed etc. independently of one another. The input data 105 may be encoded as depth-slices of node lists (with no payloads), with Depth==0 being the first slice, followed by Depth==1, and so on. This yields a simpler architecture than one that is inherently recursive. In other embodiments, rather than having nested node lists embedded in node payloads or depth slices, one could structure the data as a flattened node list (with or without payloads as above) where all nodes are extracted and not embedded within other nodes.

GUIDs may also be used in the flattened NL case, where nodes are treated sequentially, but completely atomically/separately. In this case, the GUIDs of parent nodes need to be stored with the node in question, so that the references can be checked by the core 102, and the input data is able to be reconstructed in the output transformation engine 103.

As stated above, the canonical input data 105 is compared to reference data to determine whether the input data is valid. Where the input data is arranged with a nodal structure, as described above, individual nodes are compared to associated reference data to determine whether the node satisfies a predetermined condition stipulated by the reference data.

The core 102 may check whether the content (e.g. one or more attributes or elements) of the node payload satisfies a predetermined condition stipulated by the reference data for the node. However, additionally or alternatively, the entire node list structure is compared to reference data to determine whether the node list satisfies a positive structural condition that indicates a legal node structure. With reference to the nested node structure illustrated in FIG. 3, the core 102 is setup with the relevant parts of the format schema concerned with structural rules required for the structure check. The core 102 will look for a legal node structure within the canonical input data based on predefined structural information in the format schema 104. The core 102 will verify that the Node 0 payload 202 contains a Node 1(header and payload) and a Node 2 (header and payload). The core 102 will then continue to verify that the Node 1 payload 205 contains a Node 3 (header and payload) and the Node 2 payload 206 contains a Node 4 (header and payload). Once the structure has been verified and validated, the core 102 will determine that the node list satisfies the structural condition. This structural check for the entire node list (intermediate format) can be done before any checks of individual node content is performed. Indeed, the content checks for individual nodes (data portions) may be performed only on the condition that the canonical input data has been determined to satisfy the structure checks. If the node list does not satisfy a positive condition that indicates a legal node structure then nothing else is checked until the core checks the next input data file. This may reduce core processing and in turn power consumption.

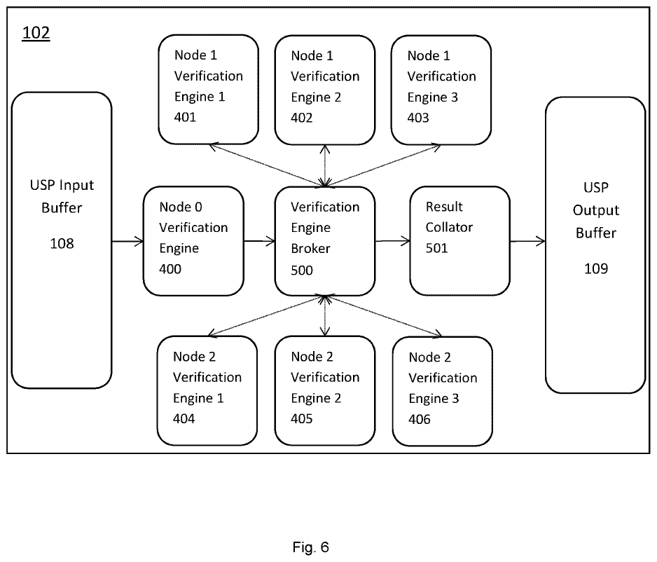

FIG. 5 is a schematic diagram of an embodiment in which the core 102 comprises multiple node verification engines 400, 401, 402, 403, 404, 405, 406 that are implemented in hardware as programmable logic on an FPGA(s) and/or baked into silicon as an ASIC(s). The core 102 can be dynamically configured in advance of receiving a set of input data 105 based on the loaded format schema 104 and other information (e.g. runtime information on the current set of input data, and/or statistical information on a historical set(s) of input data from the same or similar source domain).

Each node verification engine (VE) is to be used to process and check only a single data type or node (or generally a data portion) of the USP input data. Thus, for a given USP input data (file), a respective VE is provided for each data type in the input data (e.g. text fields). Each VE 400, 401, 402, 403, 404, 405, 406 checks a particular element or attribute of the transformed canonical input data 106 against the reference data, e.g. the format schema 104, for that data type and the core 102 accumulates the results output by each VE. Checks on the Node VEs may be broken down into sub-functions on the FPGA that handle primitive data types (e.g. Text Fields, Numerical Data (integers, or floating point values converted into fixed point)). In preferred embodiments, the sub-functions run in parallel on separate channels on the FPGA, in order to maximise speed and efficiency.

The core 102 is configured on the FPGA to contain enough resources to handle the worst case scenario, i.e. the USP input that requires the most processing by the FPGA logic, e.g. by virtue of a large number of data elements of a particular data type. When the core 102 processes USP inputs that do not require all of the FPGA logic resource, only some of the logic (VEs) will be enabled and the remaining logic (VEs) will be disabled to reduce power consumption. That is, the core 102 may be configured such that only the minimum number of verification engines required for processing the received canonical input data is enabled, and the remaining verification engines are disabled. The number and type of node verification engines to be used to check the specific input data file (USP) is defined by the format schema.

Note that FIG. 5 does not show any of the connections or data flows between the verification engines. Each verification engine takes in discretised nodes in the canonical input data 106, and performs high assurance verification on the nodes. High assurance verification provides a high degree of confidence in the security enforcing functions, and therefore the validity of the data released from the core 102. One or more of the verification engines may comprise micro-verification engines configured to check fundamental data types, for example primitives such as ‘int32’, or other common verification engines such as ‘UTF-32 PascalString’.

The node VEs may be fixedly configured to verify input data of a single, specific data type. However, in embodiments, the node VEs may have a generic architecture that can be configured to check multiple data types, including UTF-32 characters, uint32 integers, uint64 integers, int32 integers, int64 integers, IEEE 64 bit double precision floating point and IEEE 32 bit single precision floating point. All of these data types are ultimately represented by binary numbers and therefore the same generic node engine can be used to perform checks of all these data types by looking for specific numerical reference data such as a check pattern (which, if present, may be taken as an indication that the data is valid or invalid). Regardless of which data type the node VE is checking, the node VE will receive its input data as binary numbers. Therefore, the node VE may be configured with the check pattern it is looking for and does not need to know the message format or data type.

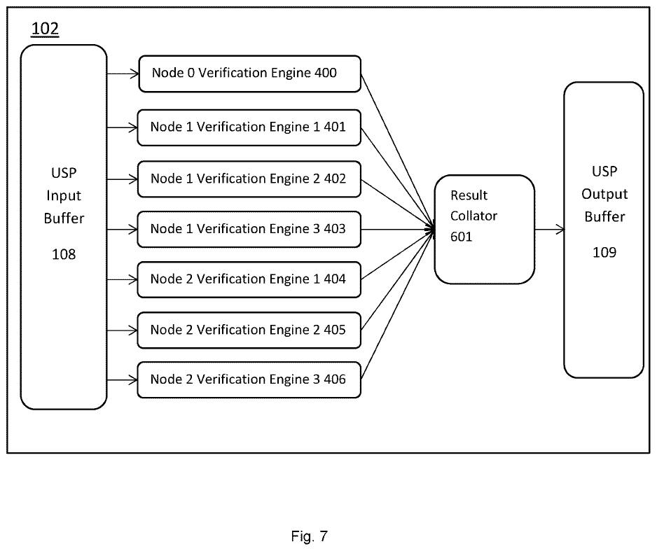

As shown in FIG. 6, the content checking may optionally be controlled by a verification engine broker 500. In the embodiment shown in FIG. 6, the core 102 comprises a USP input buffer 108, a plurality of node verification engines 400-406, a verification engine broker 500, a result collator 501 and a USP output buffer 109, all of which are implemented in hardware as programmable logic on an FPGA(s).

The canonical input data 106 which has been received from the input transformation engine 101 is stored in the USP input buffer 108, from which it can be accessed by the broker 500 and node VEs 400-406. The canonical input data 106 is passed to the Node 0 (Depth position 0) Verification Engine 400, which checks the node list against reference data to determine whether the input data 106 has a legal node structure. If the input data 106 structure is legal/valid, it is passed to the Verification Engine Broker 500 and further checks from the other Node verification engines will be allowed to proceed. Where, however, the structure is not legal, no further checks will proceed.

The verification engine broker 500 is a central processor or logic which directs each node (data portion) in the canonical input data 106 to a respective node verification engine and handles the scheduling of Nodes passed to their corresponding VEs. Each node verification engine checks compliance of the node sent by the verification engine broker 500 against the condition(s) indicated by the reference data (format schema 104), where each node checks a particular node type defined by the schema 104, such as an integer or text. The checking is preferably performed in parallel by different node verification engines, such that plural (and preferably each of the) nodes is checked simultaneously.

Once all of the nodes have been checked, the verification engine broker 500 passes the checked data to the result collator 501. If no invalid nodes are detected in the canonical input data 106 in USP input buffer 108, the result collator 501 releases the node data to the output transformation engine 103 via the USP output buffer 109 for conversion into output data 107 having the same or similar format as the original input data 105 received from the first computer system. If invalid nodes are detected in the canonical input data 106, then the node data is not released by the result collator 501. This may be advantageous in that it allows the input data to still be output by the output transformation engine 103 but with the data from invalid nodes removed. However, as described above, in embodiments the data for invalid nodes may be zeroed or modified before being released to the output transformation engine 103.

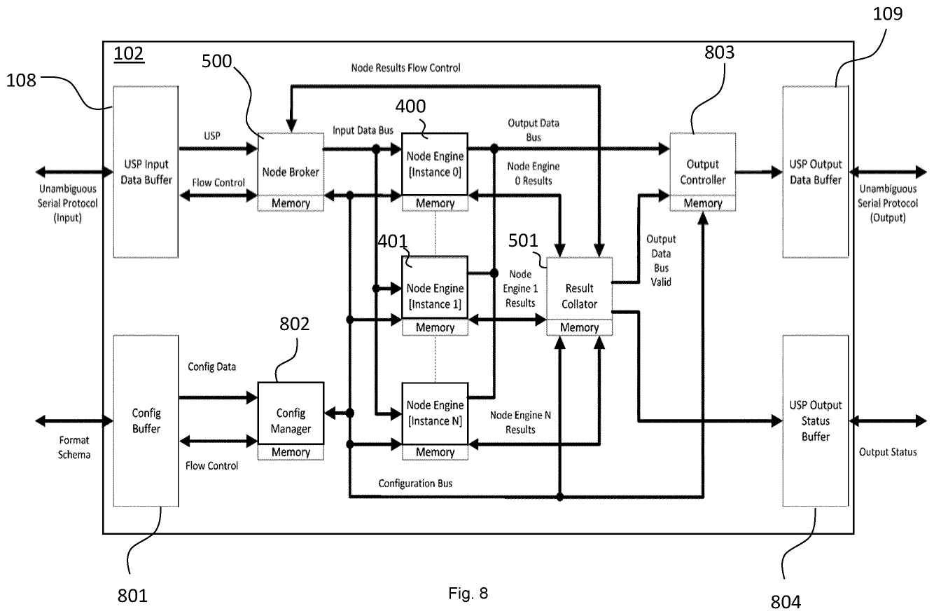

FIG. 7 shows an embodiment in which the content checking performed in hardware as programmable logic on an FPGA(s) is not directed centrally by a verification engine broker. In this embodiment, the core 102 is configured such that each data node (or generally a data portion) flows into all of the VEs in parallel. In embodiments, each VE checks whether it has been allocated to check that node (for example by comparing the received node ID to a node ID allocated to that VE by the format schema), and only the correct VE accepts the node and completes a full check while the remaining VEs reject the data. This may be useful where a simple device is required, and speed is not critical.

In FIG. 7, the canonical input data 106 is flattened in that there are no nodes (data portions) embedded within other nodes, and each node is passed to the node verification engines 401, 402, 403, 404, 405, 406 in turn for checking. The position of each node in the canonical input data structure is denoted by a global unique identifier reference. As with the other embodiments, each node verification engine is configured to only check a particular node data type such as integer etc. The result collator 601 is connected to the output of each VE and receives confirmation of which nodes have passed checking. Data processing after a node that has failed a check may vary, depending on the security level required. For example, the node, structure or depth may be removed from the data or modified, or the entire input canonical data 106 may be rejected such that no data is passed to the output transformation engine 103. In embodiments, the input data as a whole is either allowed or prohibited to pass to the output transformation engine 103 based on the result of the checks. Alternatively, only valid checked nodes are allowed to pass to the output transformation engine 103.

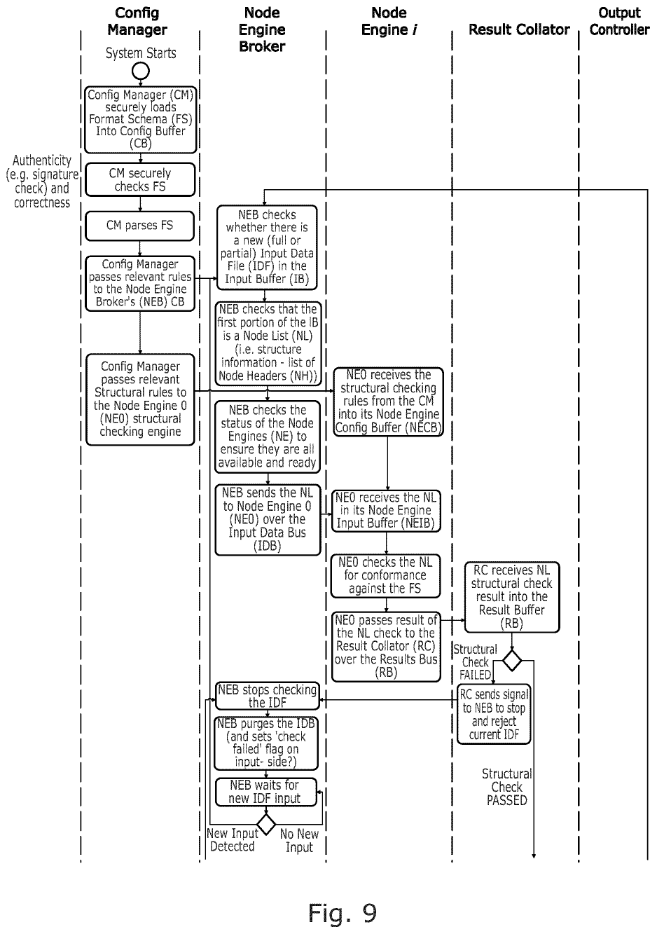

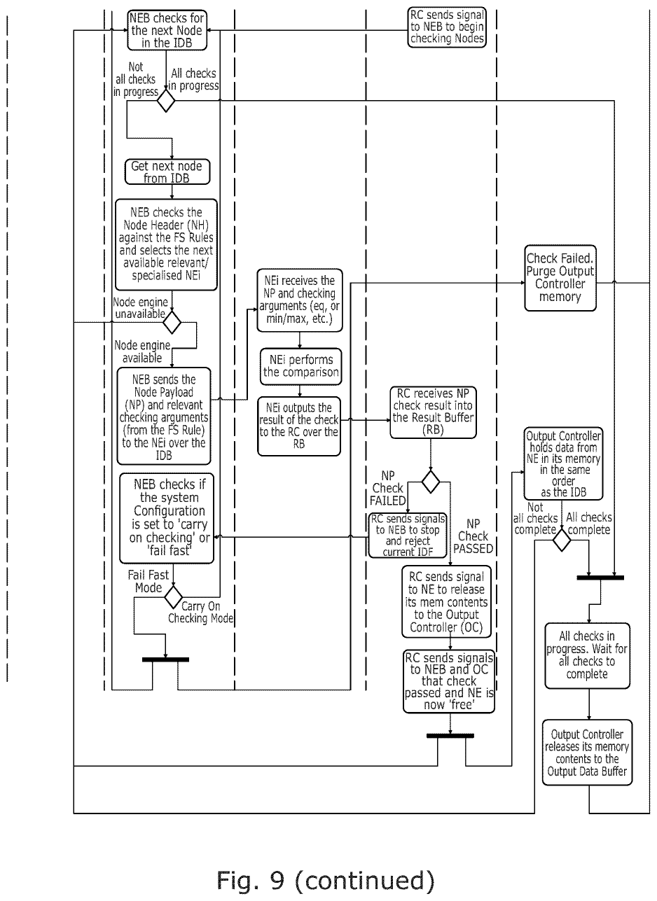

One embodiment of the method of the present invention will now be described in further detail with respect to FIGS. 8 and 9 in combination.

As can be seen in FIG. 8, the core 102 of the content checking device in this embodiment corresponds substantially to that of FIG. 6, and like reference numerals are used to denote like features. However, the core 102 of FIG. 8 differs from that of FIG. 6 in that it further comprises a configuration buffer 801, a configuration manager 802, an output controller 803 and a USP output status buffer 804, which are implemented in hardware such as programmable logic on an FPGA(s) or an ASIC(s). The output controller 803 is located between (and is in communication with) the result collator and the USP Output Data Buffer.

With reference to FIG. 9, the core 102 is initialised to carry out the step of determining whether the input data is valid. This is achieved by the configuration manager 802 loading the Format Schema into the configuration buffer 801. At this point, the configuration manager 802 may confirm the authenticity of the format schema by checking a digital signature of the format schema against a signature stored in firmware. For example, a standard X.509 name signature verification may be performed on the format schema. If the format schema is valid then the configuration manager 802 parses the format schema and passes the relevant rules to the node engine broker 500 and the node 0 verification engine 400. Specifically, node 0 verification engine 400 is set up with the relevant parts of the format schema that is concerned with the structural rules required for the structure check. This will allow the node 0 VE 400 to look for a legal node structure within the input data, by reference to the structural information in the format schema. Further, the remaining node verification engines 401, 402 etc. (i.e. those that are to be used for the input data) are sequentially given their respective conditions and check patterns that are to be used for the content checks based on the node payloads of the input data.

The node engine broker 500 checks whether there is a new input data (USP) file in the input buffer 108. The node broker 500 then determines whether structure information, specifically a node list (list of node headers), is provided in a first portion of the input buffer 108. If so, the node broker 500 passes the node list to the node 0 verification engine 400 to perform a structure check. In other embodiments, the node broker 500 builds up a Node List (concatenated sequential list of node headers) itself.

The node 0 verification engine 400 checks the node list for conformance with the format schema and informs the result collator 501 of the result. Where the structure is valid, the node broker 500 and result collator 501 will be informed that the USP file structure is valid and therefore further checks by the other node verification engines should be allowed to proceed. Where the USP file structure is invalid, the result collator 501 will be notified and all checks will stop on this notification. No data will be allowed to pass into the output data buffer 109 and the node broker 500 purges the input buffer 108 and waits for a new input data (USP) file to be received.

After it has been determined that the structure check is successful, the node broker 500 requests the next set of input data from the input data buffer 108. Immediately following the structure check this data will be the first node. The node broker 500 passes the data to the appropriate node verification engine to start a data content check. The node broker 500 will compare the header information of the node it receives from the input data buffer 108 against the format schema, allowing it to decide which preconfigured and specialised node verification engine to pass the data node to.

The appropriate node verification engine receives the node payload from the node broker 500 over an input data bus. The node verification engine then checks data against the reference data indicating the condition which is to be tested. The reference data may be a bit pattern which is to be compared to the payload data. The node verification engine then performs the comparison and outputs the result of that to the result collator 501 for storage in a results buffer.

If the check determines that the node (payload) is invalid then the result collator 501 is notified. As stated above, in embodiments all checks of the USP input data will stop on this notification. In other embodiments, however, checks for other nodes are allowed to continue. If the check determines that the node (payload) is valid then the result collator 501 is informed of that success. The output controller 803 then stores the data from the node verification engine in its internal memory buffer. The next node (if present) is then checked by an associated node verification engine until all nodes have been checked by a node engine and stored by the output controller 803 or, e.g., until an invalid result has been declared for a node. In that regard, the Node Broker 500 and Result Collator 501 communicate via a Node Results Flow Control link, via which the Node Broker 500 initially feeds the Result Collator 501 with the expected set of results to collate (e.g. a list of checks whose results are to be collated). Where multiple node verification engines are used to check the USP input data, the result collator 501 waits until all node verification engines have completed their checks and the expected set of results (as indicated to the Result Collator by the Node Broker 500) have been collated. In other embodiments, the Node Broker 500 does not feed the Result Collator 501 with the expected set of results to collate but instead dynamically informs the Result Collator 501 to release all node verification engines when the checks have been completed.

When all node verification engines have finished, the result collator 501 will issue a notification to flag to the output status buffer 804 whether the USP input data file is valid or invalid. At or near the same time, the output controller 803 releases its memory contents, i.e. the nodes, to the output data buffer 109 from which it can be passed to the output transformation engine 103 for further processing before being passed to the second computer system.

In the manner described above, it can be seen that the present invention provides a method and device for verifying the validity of data which is transmitted between computer systems, and taking action (i.e. either allowing or preventing onwards transmission) accordingly based thereon.

It will be appreciated that whilst various aspects and embodiments of the present invention have heretofore been described, the scope of the present invention is not limited to the embodiments set out herein and instead extends to encompass all methods and arrangements, and modifications and alterations thereto, which fall within the scope of the appended claims.

1. A method for use in a content checking device for checking data transmitted from a first computer system to a second computer system, wherein the method comprises:
receiving a set of input data from the first computer system, wherein the set of input data is received in a first format;
transforming the set of input data from the first format to an intermediate format which is known to the content checking device, wherein the intermediate format has a canonical data structure comprising a set of unambiguous serialised data portions;
determining whether the set of input data is valid by comparing a data portion to reference data; and
controlling a flow of input data to the second computer system based on the determination.

2. The method of claim 1, wherein;
each data portion comprises header information and payload information; and
the method comprises comparing the payload information of the data portion to the reference data.

3. The method of claim 1, wherein the canonical data structure is a hierarchical nodal data structure wherein each data portion corresponds to a node and one or more of the data portions are embedded within a payload of another data portion.

4. The method of claim 1, wherein the canonical data structure is flattened in that the data portion is stored and processed independently of another data portion.

5. The method of claim 1, wherein:
a data portion of the set of input data comprises text string data;
the reference data comprises one or more predefined text strings which represent banned or denied information;
comparing the text string data to the predefined text string; and
the set of input data is determined to be invalid if the data portion comprises a text string within the text string data that matches the predefined text string.

6. The method of claim 5, further comprising skipping or ignoring at least one whitespace character of the text string data when comparing the text data string data to the predefined text string.

7. The method of claim 1, in response to determining that the set of input data is not valid, further comprises:
discarding or ignoring the set of input data such that it is not used by the second computer system; or
modifying the set of input data such that the modified set of input data is suitable for use by the second computer system.

8. The method of claim 1, wherein the step of determining whether the set of input data is valid by comparing a data portion to reference data is carried out by hardware.

9. The method of claim 1, wherein each serialised data portion comprises data having a single data type.

10. The method of claim 1, wherein comparing a data portion to reference data is performed by passing the data portion to a programmable logic verification engine that has been preconfigured to compare one or more attributes of the data portion to reference data for a data type.

11. The method of claim 1, wherein:
the reference data for a given data portion indicates a predefined condition which can be used by the content checking device to characterise the data portion as valid; and
the method comprises checking whether the content of the data portion satisfies the predefined condition stipulated by the reference data for the data portion, and determining whether the set of input data is valid.

12. The method of claim 1, wherein determining whether the set of input data is valid further comprises checking that the set of input data has been correctly transformed to the intermediate format by comparing the set of input data with predefined reference data that indicates a valid data structure.

13. The method of claim 12, wherein the comparing a the data portion to the reference data performed when the set of input data has been correctly transformed to the intermediate format.

14. The method of claim 1, wherein in response to determining that the set of input data is valid, the method comprises converting the set of input data from the intermediate format to a final format for use by the second computer system.

15. The method of claim 14, wherein the final format is the same as the first format.

16. The method of claim 1, wherein:
the content checking device comprises a processing core of programmable logic verification engines e suitable for comparing respective data portions to reference data; and
the reference data specifies a known or predicted number of data portions in the set of input data and the processing core is dynamically configured for the set of input data to activate a number of verification engines matching the known or predicted number of data portions.

17. The method of claim 10, wherein:
the reference data for a given data portion indicates a predefined condition which can be used by the content checking device to characterise the data portion as valid;
the method comprises checking whether the content of the data portion satisfies the predefined condition stipulated by the reference data for the data portion, and determining whether the set of input data is valid;
the predefined condition is specific to a known or predicted data type of the data portion in the set of input data; and
a verification engine is dynamically configured for the set of input data to check whether the content of the data portion satisfies the predefined condition which is specific to the data portion.

18. A content checking device, comprising:
an input transformation engine configured to receive a set of input data from a first computer system in a first format and transform the set of input data from the first format to an intermediate format of the content checking device, wherein the intermediate format has a canonical data structure comprising a set of unambiguous serialised data portions; and
a core is configured to determine whether the set of input data is valid by comparing a data portion to reference data,
wherein the content checking device is further configured to control a flow of input data to a second computer system based on the determination.

19. The content checking device of claim 18, wherein the core is implemented on hardware.

20. The content checking device of claim 18, wherein:
the set of input data comprises plural data types and each data portion includes data of a respective data type;
the core comprises a plurality of verification engines; and
each verification engine of the plurality of verification engines is configured to process a respective data portion only, by comparing the data portion to reference data for that data type only.
